(19) United States
(12) Patent Application Publication
(10) Pub. No.: US 2010/0077020 A1
(43) Pub. Date: Mar. 25, 2010

(54) METHOD, APPARATUS AND COMPUTER PROGRAM PRODUCT FOR PROVIDING INTELLIGENT UPDATES OF EMISSION VALUES

(75) Inventors: Harri Paloheimo, Espoo (FI); Timo Rantalainen, Helsinki (FI); Ville Kononen, Oulu (FI); Jussi Liikka, Oulu (FI); Arttu Lamsa, Oulu (FI); Miikka Ermes, Ruutana (FI); Eero Rasanen, Tampere (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/236,276

(22) Filed: Sep. 23, 2008

(51) Int. Cl. G06F 15/16; G06F 15/00

(52) U.S. Cl. 709/203; 702/188

(57) ABSTRACT

An apparatus for providing intelligent updates of emission values may include a processor. The processor may be configured to send a user context to request updated emission values associated with the user context. The processor may be further configured to receive the requested emission values associated with the user context and update current emission values with the received emission values. The processor may be additionally configured to provide for an output of the updated emission values. Associated methods and computer program products may also be provided.

### TECHNOLOGICAL FIELD

Embodiments of the present invention relate generally to communications technology and, more particularly, relate to apparatuses, methods and computer program products for enabling the provision of intelligent updates of emission values.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to and between users and other entities. With the aid of wireless and mobile networking technologies the availability of wireless communications devices has increased, due in part to reductions in cost of devices and the construction of infrastructures able to support these devices. Since consumers can more readily own and/or utilize a wireless communications device, the demands for dynamic functionality of these devices has increased. The marketplace has responded to these demands by providing increased functionality to the devices. For example, conventional wireless communications devices may detect a travel method by using various sensory elements. Moreover, conventional wireless communications devices may access the Internet and, as such, access existing carbon calculators, that are available on the Internet, for estimating carbon dioxide (CO₂) emissions of a travel method.

However, as the number of travel methods increase, the algorithms for automatically detecting a travel method become complicated, difficult to differentiate between travel methods (hence produce erroneous results), and consume considerable power. Moreover, these existing carbon calculators heavily depend on user input. In this regard, the calculation of CO₂ emissions from a travel requires user input of weekly, monthly or yearly estimates for distances traveled via various travel methods (e.g., car, bus, or train). However, it may be difficult for the average user to estimate or remember information related to distances traveled during a period of time via these various travel methods. As such, the estimate for CO₂ emissions may be erroneous.

Accordingly, it may be desirable to provide carbon calculators that require less user input based at least in part on intelligent updates of carbon emissions values. Additionally, it may also be desirable to provide automatic detection of travel methods that is accurate and includes efficient power management.

### BRIEF SUMMARY

A method, apparatus and computer program product are therefore provided that may enable the provision of intelligent updates of emission values. Thus, for example, intelligent updates of carbon dioxide emission values associated with a user context may be received and thus, carbon dioxide emission(s) for one or more particular travels may be more accurately computed.

In one example embodiment, a method of providing intelligent updates of emission values is provided. The method may include sending a user context to request updated emission values associated with the user context. The method may further include receiving the requested emission values associated with the user context and updating current emission values with the received emission values. The method may also include providing for an output of the updated emission values.

In another example embodiment, a computer program product for providing intelligent updates of emission values is provided. The computer program product may include at least one computer-readable storage medium having computer-executable program code portions stored therein. The computer-executable program code portions may include a first program code instructions, second program code instructions, third program code instructions, and fourth program code instructions. The first program code instructions may be for sending a user context to request updated emission values associated with the user context. The second program code instructions may be for receiving the requested emission values associated with the user context. The third program code instructions may be for updating current emission values with the received emission values. The fourth program code instructions may be for providing for an output of the updated emission values.

In another example embodiment, an apparatus for providing intelligent updates of emission values is provided. The apparatus may include a processor that may be configured to send a user context to request updated emission values associated with the user context. The processor may be configured to receive the requested emission values associated with the user context and update current emission values with the received emission values. The processor may also be configured to provide for an output of the updated emission values.

In yet another example embodiment, an apparatus for providing intelligent updates of emission values is provided. The apparatus may include means for sending the user context to request updated emission values associated with the user context. The apparatus may further include means for receiving the requested emission values associated with the user context and means for updating current emission values with the received emission values. The apparatus may further include means for providing for an output of the updated emission values.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an example embodiment of the present invention;

FIG. 2 is a schematic block diagram of an apparatus for providing intelligent updates of emission values according to an example embodiment of the present invention;

FIG. 3 is a schematic block diagram of another system according to an example embodiment of the present invention;

FIG. 4 illustrates an example graphical representation of a user interface according to an embodiment of the present invention;

FIG. 5 is a schematic block diagram of a mobile terminal according to an example embodiment of the present invention; and

FIG. 6 is a flowchart according to an example method of providing intelligent updates of emission values according to an embodiment of the present invention.

### DETAILED DESCRIPTION

Embodiments of the present invention now will be described more fully hereinafter with reference to the accompanying drawings, in which some, but not all embodiments of the inventions are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. As further used herein, “cell identification” (CellId) may refer to an identifier (e.g., number) associated with a geographic area covered by a base station in a mobile network. Moreover, as used herein, “carbon dioxide”, “CO₂”, or “carbon” may be used interchangeably to refer carbon dioxide. Additionally as used herein, “context”, “user context”, or “context framework” may be used interchangeably to refer to data or sources thereof that provide context or other associated or explanatory information related to a user, a device or the like such as, for example, geographical location (e.g., based at least in part on CellId), values recorded by various sensor elements (e.g., accelerometer, global positioning system (GPS), microphone, etc.), user preferences, flight mode information, and/or the like. Thus, use of any such terms should not be taken to limit the spirit and scope of embodiments of the present invention. Moreover, although exemplary embodiments of the present invention may be described with respect to CO₂, other embodiments of the present invention may be equally applicable to other types of emissions and/or the monitoring of other gaseous discharges, ecological footprint, water footprint, Material Intensity Per Unit of Service (MIPS), and/or the like.

According to an exemplary embodiment, an intelligent carbon calculator application (also referenced herein as a “carbon calculator”) may be resident on or otherwise associated with a user device, such as a mobile terminal. In this regard, the carbon calculator may be configured to automatically detect travel methods based at least in part on data received from one or more various sources (e.g., CellId, GPS coordinates, acceleration data, and audio data) and calculate carbon dioxide emission for the travel methods. In some embodiments, the carbon calculator may be configured to automatically detect travel methods based at least in part on a screen saver status indicator of a user device. For example, the carbon calculator may detect that the screen saver is off which may indicate that the user may be most likely holding the device may be in the user's hand and, as such, sensor measurements (e.g., accelerometer) may be distorted. Further, the carbon calculator may be configured to detect a geographical location (e.g. a country) and/or information associated therewith based at least in part on a network to which the terminal is attached (e.g., via Mobile Country Code (MCC)). The carbon calculator may be configured to send the geographical location to a network device, such as a server (e.g. a carbon dioxide emission server). In response, the carbon calculator may be configured to receive from the network device at least one carbon dioxide emission value for that geographical location. As such, the carbon calculator may be able to calculate carbon dioxide emissions for at least one travel method. In some embodiments, the carbon calculator may receive carbon dioxide emission values for the various travel methods available for that geographical location. As such, the carbon calculator may be able to identify all the travel methods available in that geographical location, improve travel method detection, and calculate the CO₂ emissions for the travel methods. The carbon calculator may also be configured to receive from the network device new travel methods. These and other features of the present invention will be explained in further details below.

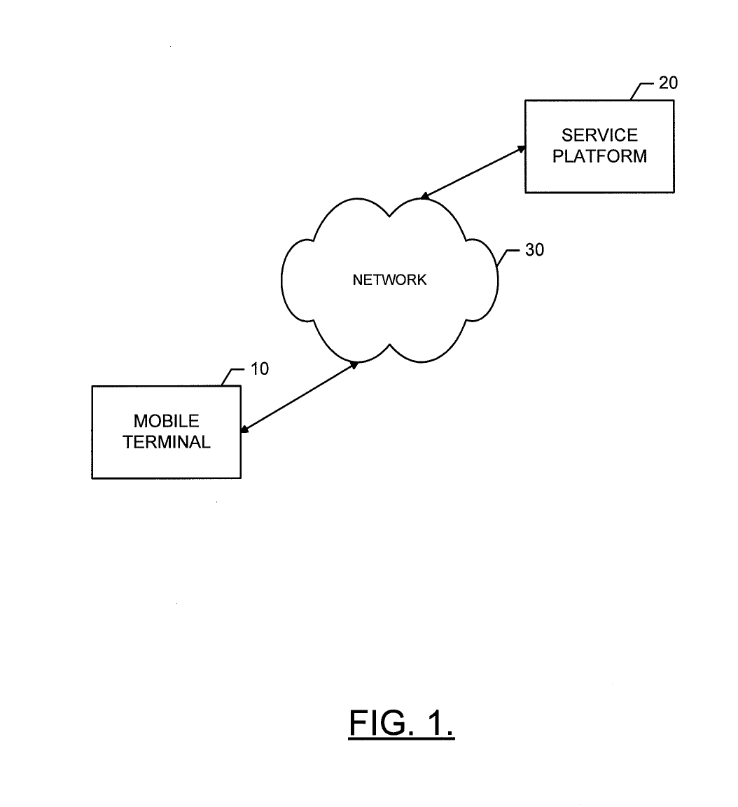

An example of an architecture of a system for supporting an exemplary embodiment of the present invention will now be described in reference to FIG. 1 which provides a schematic block diagram of a system for providing device security. In this regard, FIG. 1 illustrates a general architecture of system including a user device, such as a mobile terminal 10, in communication with a network device (e.g., service platform 20) via a network 30.

The network 30 may include a collection of various different nodes, devices or functions that may be in communication with each other via corresponding wired or wireless interfaces. As such, the illustration of FIG. 1 should be understood to be exemplary of a broad view of certain elements of the system and not an all inclusive or detailed view of the system or the network 30. One or more mobile terminals 10 may each include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other computing devices (e.g., personal computers, server computers or the like) can be coupled to the mobile terminal 10 via the network 30. By directly or indirectly connecting mobile terminals 10 and other devices to the network 30, the mobile terminal 10 may communicate with the other devices or other mobile terminals, for example, according to numerous communication protocols including Hypertext Transfer Protocol (HTTP) and/or the like, to thereby carry out various functions of the mobile terminal 10.

Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols or the like. Furthermore, although not shown in FIG. 1, the mobile terminal 10 may communicate in accordance with, for example, radio frequency (RF), Bluetooth (BT), Infrared (IR) or any of a number of different wireline or wireless communication techniques, including local area network (LAN), wireless local area network (WLAN), Worldwide Interoperability for Microwave Access (WiMAX), WiFi, ultra-wide band (UWB) techniques, infrastructure independent solutions (ad hoc network(s), sensor network(s), mesh network(s), etc.), and/or the like.

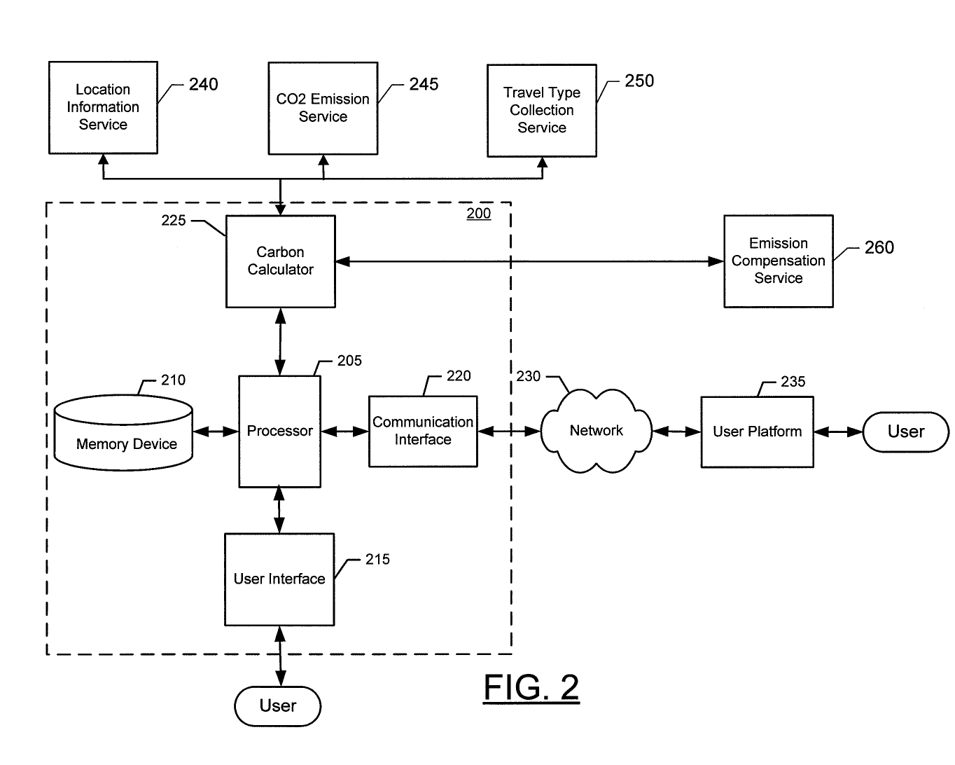

In an exemplary embodiment, the service platform 20 may be a device or node such as a server or other computing device. The service platform 20 may have any number of functions or associations with various services (e.g., a website, a social networking website, a blog, a web feed, or a widget, and/or the like). As such, for example, the service platform 20 may be a platform such as a dedicated server (or server bank) for CO₂ emissions calculation associated with a carbon emission service, location information service (e.g., based at least in part on CellId), an emission compensation service, a travel type data collection service, and/or the like. In the alternative, the service platform 20 may be a backend server for CO₂ emission calculation associated with one or more other functions or services (e.g., a social networking website) having additional capability for supporting any one or all of the above mentioned services as described herein, as well as including, but not limited to, comparison of carbon emissions between users (e.g., subscribers to the service(s) of the service platform 20), challenge(s) amongst other users to decrease their carbon emissions, competition amongst other users based at least in part on their carbon emissions, and/or the like. The functionality of the service platform 20 may be provided by hardware and/or software components configured to operate in accordance with embodiments of the present invention. An exemplary apparatus that could be embodied as either the mobile terminal 10 or the service platform 20 and configured in accordance with embodiments of the present invention will be explained below in reference to FIG. 2.

An example embodiment of the invention will now be described with reference to FIG. 2, in which certain elements of an apparatus 200 for providing intelligent update of CO₂ emission values are displayed. The apparatus 200 of FIG. 2 may be employed, for example, on a user device, e.g., the mobile terminal 10, and/or the server platform 20. Furthermore, it should be noted that the apparatus 200 of FIG. 2, may also be employed on a variety of other devices, both mobile and fixed, and therefore, embodiments of the present invention should not be limited to application on devices such as those listed above. Alternatively, embodiments may be employed on a combination of devices including, for example, those listed above. Moreover, embodiments of the present invention may be embodied wholly at a single device or by a combination of devices such as when devices are in a client/server relationship. Furthermore, it should be noted that the devices or elements described below may not be mandatory and thus some may be omitted in certain embodiments.

Referring now to FIG. 2, an apparatus 200 for providing intelligent update of CO₂ emission values is provided. The apparatus 200 may include or otherwise be in communication with a processor 205, a user interface 215, a communication interface 220 and a memory device 210. The memory device 210 may include, for example, volatile and/or non-volatile memory. The memory device 210 may be configured to store information, data, applications, instructions and/or the like for enabling the apparatus to carry out various functions in accordance with example embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information and/or media content.

The processor 205 may be embodied in a number of different ways. For example, the processor 205 may be embodied as various processing means such as one or more of a processing element, a coprocessor, a controller or various other processing devices including integrated circuits such as, for example, an ASIC (application specific integrated circuit), an FPGA (field programmable gate array), a hardware accelerator, and/or the like. In an example embodiment, the processor 205 may be configured to execute instructions stored in the memory device 210 or otherwise accessible to the processor 205.

Meanwhile, the communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna and supporting hardware and/or software for enabling communications with a wireless communication network. In fixed environments, the communication interface 220 may alternatively or also support wired communication. As such, the communication interface 220 may include a communication modem and/or other hardware/software for supporting communication via cable, DSL, universal serial bus (USB) or other mechanisms.

The user interface 215 may be in communication with the processor 205 to receive an indication of a user input at the user interface 215 and/or to provide an audible, visual, mechanical or other output to the user. As such, the user interface 215 may include, for example, a keyboard, a mouse, a joystick, a touch screen, a display, a microphone, a Global Positioning System (GPS), an accelerometer, a flight mode indicator, a speaker, or other input/output mechanisms. In an example embodiment in which the apparatus 200 is embodied as a server or some other network devices, the user interface 215 may be limited, or eliminated.

In an example embodiment, the processor 205 may be in communication with or be embodied as, include or otherwise control a carbon calculator 225. The carbon calculator 225 may be any means such as a device or circuitry embodied in hardware, software or a combination of hardware and software, such as the processor operating under software control, that is configured to perform the corresponding functions of the carbon calculator 225 as further described below. The means of the carbon calculator 225 may include, for example, means for sending a user context to request updated emission values associated with the user context, means for receiving the requested emission values associated with the user context, means for updating current emission values with the received emission values, and means for providing for an output of the updated emission values, embodied as, for example, hardware elements (e.g., a suitably programmed processor, combinational logic circuit, and/or the like), computer code (e.g., software or firmware) embodied on a computer-readable medium (e.g. memory device 210) that is executable by a suitably configured processing device (e.g., the processor 205), or some combination thereof. In some embodiments, the carbon calculator 225 may perform various functions including, but not limited to, performing segmentation, classifying travel methods, calculating traveled distance, calculating carbon emission, and performing other types of analysis and/or the like. In this regard, the carbon calculator 225 may be configured to perform segmentation by dividing data (e.g., collected from GPS or accelerometer) into segmentation blocks such as, for example, human performed movement(s) or motor-driven movement(s). The carbon calculator may be configured to classify travel methods to process the segmented data and identify the travel methods (e.g., walking, biking, running, for human performed movement(s), or car, bus, train, for motor-driven movement(s)).

In this regard, the carbon calculator 225 may be configured to automatically detect travel methods, such as, for example, car/motorcycle, bus, tram, metro, train, airplane, or human performed movements (e.g., walking, running, biking, etc.). As such, the carbon calculator 225 may be configured to collect data from different sources such as, for example, CellID, GPS, accelerometer, audio device (e.g., microphone), other sensory device(s), flight mode information, and/or the like. One or more of these data or data sources may be included in a user context or context framework. In this regard and for example, the user context may comprise CellId, accelerometer data, GPS coordinates, audio data, flight mode information and/or the like. The carbon calculator 225 may be configured to use various algorithms such as, for example, statistical pattern recognition, to detect the current travel method. In this regard, the carbon calculator may store signals and other data collected during a data collection session (e.g., user travel) by the data sources on a storage device, such as, for example, memory device 210, or a remote storage device, and determine the travel method based at least in part on the signals or other data. For example, during a data collection session, a microphone (or other audio data collecting device) may collect audio samples of a car engine, a train, and/or bus. As such, the carbon calculator 225 may analyze the data and determine that the travel method include a car, a train, and/or a bus, respectively, such as based upon a comparison of the collected data to predefined data indicative of each of the different modes of transportation. The carbon calculator 225 may also be configured to detect travel methods based at least in part on user preferences that may be stored on a storage device locally associated with the apparatus 200 such as, for example, memory device 210 or on a storage device remotely associated with the apparatus 200. In this regard and for example, the carbon calculator 225 may retrieve user preferences information, identify the travel methods preferred by the user, analyze data (e.g., accelerometer data, GPS data, etc.) collected during a travel, and determine the travel method(s) used during the travel, generally from amongst those preferred by the user.

In some embodiments, the carbon calculator 225 may segregate the detection of flight travel methods and non-flight travel methods. In this regard, the carbon calculator 225 may detect when a flight mode status is activated. As such, the carbon calculator 225 may store the current CellId, time, location (e.g., GPS data), and/or the like. Upon detection that the flight mode status is no longer activated, the carbon calculator 225 may store the new CellId, time, location, (e.g., GPS data), and/or the like. With respect to non-flight travel methods, the carbon calculator may detect a movement of the apparatus 200 and determine whether the movement is a human performed movement (e.g., walking, biking, running, etc.) such as by comparing the sensed parameters, e.g., speed, acceleration, etc., to predefined parameters indicative of each of the different types of human performed movement. If the movement is human performed, the carbon calculator 225 may additionally determine the periodicity of the movement. If the movement is not human performed (e.g., motor driven), the carbon calculator 225 may determine the exact type of travel method (e.g., car, train, motor bike, etc). In some embodiments, the carbon calculator 225 may also determine the periodicity of a non-human performed movement (e.g., car, train, motor bike, other public transportation, etc.).

As mentioned above, the carbon calculator 225 may also be configured to calculate traveled distance based at least in part on GPS data and/or accelerometer data. The carbon calculator 225 may also be configured to calculate carbon dioxide emission based at least in part on traveled distance, travel type, travel time, and/or the like. The carbon calculator 225 may further be configured to determine at least a travel method or rule out alternative at least one travel method based at least in part on at least one traveled path. For example, a user may be traveling by sea, and such as, travel methods not by sea may be excluded. In some embodiments, the carbon calculator 225 may configured to detect another carbon calculator within a predetermined distance, that is, within a predefined proximity. In this regard, the carbon calculator 225 and the other carbon calculator may exchange information, such as, for example, update carbon emission values for a geographical location, as will be described in further details below. In other embodiments, the carbon calculator 225 may also be configured to detect a short-range communications device or service (e.g., Bluetooth) within a predetermined distance, which may be, for example, associated with a vehicle (e.g., car, bus, etc.) that may output information (e.g., information regarding the vehicle's emissions, driving habits, etc.). As such, the carbon calculator 225 may calculate carbon emission based at least in part on the information received from the other carbon calculator, a short-range communication device or service, and/or the like.

The carbon calculator 225 may be in communication with one or more services that may provide and/or store information useful in connection with embodiments of the present invention. The services may include, for example, a location information service 240, a CO₂ emission service 245, a travel type collection service 250, and an emission compensation service 260. One or more of these services may be embodied as a server and the server may include a database. In this regard and for example, the location information service may include a database that may store information relating to location and the CO₂ emission service may include a database that may store carbon emission values. Similarly and for example, the travel type collection service may include a database that may store information relating to various types of travel methods.

As mentioned above, the location information service 240 may be embodied as a server that may include a database that may store information relating to location (e.g., geographical location) and/or the like. In some embodiments, the location information service 240 may store a list of Mobile Country Codes (MCC). In this regard, the location information service 240 may be configured to process requests for location information. As such and for example, the carbon calculator 225 may be configured to detect a CellId associated with the apparatus 200 and forward a request to determine a geographical location (e.g., country, state, city, etc.) based at least in part on the CellId. The location information service 240 may process the request from the carbon calculator 225 and forward the geographical location (e.g., country, state, city, etc.) and other related information associated with the CellId to the carbon calculator 225. The geographical location and other related may be stored on a storage device locally associated with the apparatus 200 such as, for example, memory device 210 or on a storage device remotely associated with the apparatus 200. In some embodiments, the carbon calculator 225 may be configured to cause the geographical location and other related information to be stored. The geographical location and other related information may be later retrieved for processing as will be discussed below.

As mentioned above, the CO₂ emission service 245 may include a database that may store carbon emission values for various geographical locations (e.g., country, state, city, etc.). The database may also store target carbon emission values for at least one geographical location (e.g., target level for a year, month, etc.). Additionally, the database may store carbon dioxide emission values for at least travel method available in the geographical location. Moreover, one or more travel methods may be further defined into sub-types. For example, a car may be defined as an old car and new car and as such, the database may store the emission values for each subtype. The database may also store additional information related to the geographical location, such as, for example, the coordinates of relevant transportation locations and hubs. In this regard, the carbon calculator 225 may send a request to the CO₂ emission service 245 including a geographical location determined by the process discussed above. In some embodiments, the CO₂ emission service 245 may also include and/or be associated with another global database that may store various information including, for example, emissions of users (e.g., travelers), frequently used travel methods, and/or the like. As such, the information may be used for various purposes including, for example, zone planning, improvement of transit possibilities in one or more geographical locations, and/or the like. In other embodiments, the carbon calculator 225 may send a request further including one or more travel methods and as such, request carbon emission values and other related information for one or more specific travel methods. The CO₂ emission service 245 may in turn forward the correct emission values and other related information associated with the geographical location to the apparatus 200. The carbon calculator 225 may cause the received correct emission values and other related information (“received information”) to be stored on a storage device locally associated with the apparatus 200 such as, for example, memory device 210 or on a storage device remotely associated with the apparatus 200. As such, the carbon calculator 225 may use the received carbon dioxide emission values for the geographical location and other related information in the calculation of carbon dioxide emission for a user travel.

The carbon calculator 225 may also process the received information and identify the available travel methods for the geographical location based at least in part on the received information. As such, the travel detection algorithm(s) may be simplified, based at least in part on the identified travel methods available (and hence reduced travel methods alternatives and calculation required), and the accuracy of travel detection may be increased. In this regard, possible travel methods for a geographical location may be limited by the received information and the carbon calculator may detect a travel method based at least in part on the received information. Moreover, and as mentioned above, the carbon calculator 225 may detect a travel method based at least in part on user preferences. In this regard, the user preferences may be updated based at least in part on the received information. In some embodiments, the carbon calculator 225 may monitor the geographical location of a user and the user preferences may be ignored if the user is not a location within a predetermined distance from the geographical location associated with the user preferences (e.g., user home geographical location). Additionally, the carbon calculator 225 may receive an update of new travel methods with their associated carbon emission values and other related information for the geographical location based at least in part on the received information. These updates may be automatic (e.g., periodic, or triggered by some action, e.g. change of serving network) or initiated by a user (e.g., user initiated or manual travel method update from the server). In some embodiments, and as mentioned above, the received information may comprise the coordinates of relevant transportation locations and hubs. As such, the carbon calculator 225 may detect a travel method based at least in part on the coordinates of relevant transportation hubs and locations. For example, the carbon calculator 225 may detect a travel method based at least in part on a starting location (or coordinate) of a travel and an ending location (or coordinate) of the travel.

The travel type collection service 250 may store and/or provide information relating to various types of travel methods. In some embodiments, the travel type information may be used to provide advice to the user on how to decrease emissions. For example, the travel type collection service 250 may suggest alternative travel methods such as, for example, public transportation or other forms of ride sharing. In other embodiments, the carbon calculator 225 may be configured to send generated travel method data for a specific geographical location to the travel type service 250, such as, for example, new travel methods identified by a user. In this regard, the generated travel method data may include start and stop times of a travel method, an identification of a travel method, CO₂ emissions of a travel method, user defined flag (e.g., to determine whether a user has modified the data) of a travel method, confidence value for the identification of the travel method (e.g., a rating calculated by the carbon calculator 225 regarding the certainty in identifying the travel method), an estimated traveled distance, a set of location coordinates for the travel, and/or additional information.

The emission compensation service 260 may be configured to provide compensation (or carbon offset) based at least in part on the carbon dioxide emissions calculated by the carbon calculator 225 (e.g., purchasing ‘credits’ from emission reduction projects). In this regard and in some embodiments, the carbon calculator 225 may be configured to remind the user to request compensation for the carbon dioxide emissions generated by the user. In other embodiments, the carbon calculator 225 may be configured, for example, by the user, to periodically initiate compensation of the emission calculated during a predetermined period of time from the emission compensation service 260. The predetermined period may coincide with the period for initiating compensation.

In an example embodiment, the apparatus 200 may include a power management component (not shown). The power management component may comprise various power saving/sleep state functionalities, such as, for example, power saving/sleep state based at least in part on sensory inactivity and user defined power saving/sleep state periods, power save modes, and/or the like. In this regard and according to one embodiment, the carbon calculator application may be activated and take a sample of data from a sensor (e.g., accelerometer). For example, the application may determine that the apparatus is stationary and thus, the application may return to a power saving/sleep state period. In some embodiment, each time the application returns to a power saving/sleep state if the apparatus is stationary, the sleep state time may be increased but not beyond a predetermined amount of time. In another example, the application may determine that the apparatus 200 is moving and thus proceed to detect the travel method. The application may determine that the travel method does not emit CO₂ (e.g., walking, riding bicycle, etc.) and may thus return to a power saving/sleep state. In this regard and as mentioned above, the power saving/sleep state time period may increase but not beyond a certain time. Alternatively, the application may determine that the travel method emits CO₂, in which case the application may start recording data from the acceleration. In some embodiments, several activities may activate the application such as, for example, a change in CellId, lost WLAN connection, activation of GPS, etc.

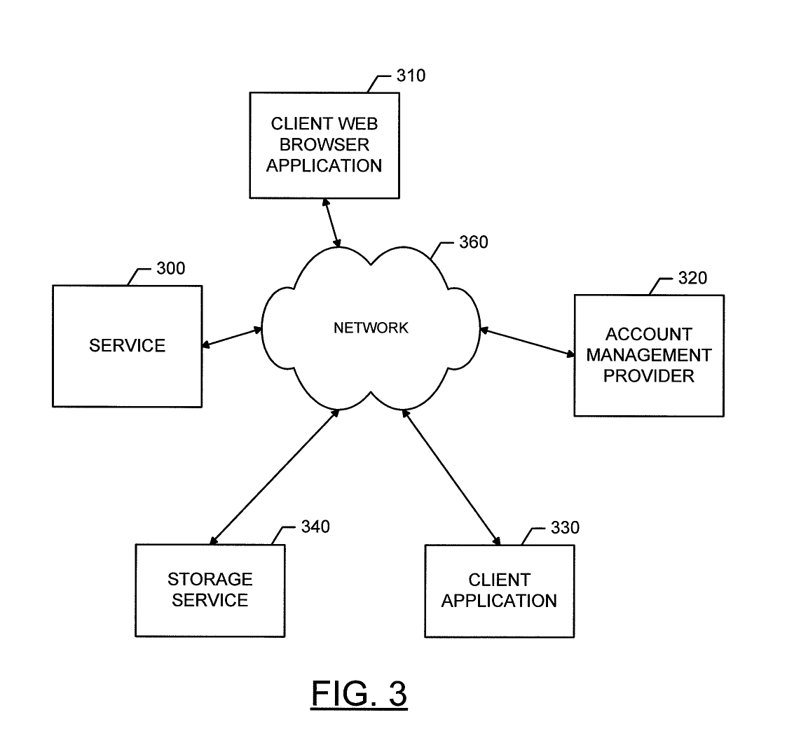

Referring now to FIG. 3, an embodiment of a system in accordance with an example embodiment of the present invention is illustrated. The system of FIG. 3 may include a service 300, a client web browser application 310, an account management provider 320, a client application 330, and a storage service 340. The service 300, the client web browser application 310, the account management provider 320, the client application 330, and the storage service 340 may be interconnected via the illustrated network 360. Furthermore, each of the service 300, the client web browser application 310, the account management provider 320, the client application 330, and the storage service 340 may be any device or means embodied in hardware, software or a combination of hardware and software configured for the performance of the corresponding functions of the service 300, the client web browser application 310, the account management provider 320, the client application 330, and the storage service 340, respectively, as described below.

In an example embodiment, the service 300, the account management provider 320, and the storage service 340, which may include memory, may collectively represent and/or employ an internet or network service (e.g., a website, a social networking website, a media storage website, a blog website, a web feed, a widget, a service platform, a server, and/or the like) that may receive and interact with requests from users via the client application 330 and/or the client web browser application 310. In some cases the service 300 may enable users to utilize the storage service 340 for storage and retrieval of their carbon emissions or information relating to the calculation of carbon emission (e.g., carbon emission values).

The account management provider 320 may operate together with the various other network entities to perform account management and security features. In some embodiments, login information and passwords are first directed to the account management provider 320 for verification. Upon verification, the account management provider 320 may provide access to, and allow communications between, various network entities using, for example, a token or other access key. In some embodiments, the security features may comprise performing a check on the identifier of a user's user identity module (UIM) upon initialization of the carbon calculating application so as to, for example, restrict the calculation and/or improvement of emissions data to a single user. The UIM may include, for example, a subscriber identity module (SIM), a universal integrated circuit card (UICC), a universal subscriber identity module (USIM), a removable user identity module (R-UIM), etc. Similarly, call forwarding status may be recorded to restrict the change from one user device to another and forward communications to the actual user.

Client application 330 may be a hardware or software application residing and operating on a platform (e.g., a user platform), such as a computer, mobile terminal, and/or the like, that may be used to interact with the service 300. The client application 330 may be downloaded to and/or installed on the platform. In some embodiments, the client application 330 may be specifically tailored to interact with the service 300, that is, the client application 330 may be a dedicated application. Via the client application 330, the platform, and the user of the platform, may interact with the service 300 to send and receive calculated carbon emissions (and/or any modifications thereof) or information relating to carbon emission values between the client application 330 and the service 300. In some embodiments, the client application 330 may be a carbon calculator client application such as, for example, the carbon calculator 225 in FIG. 2.

Similar to the client application 330, the client web browser application 310 may be a hardware or software application residing and operating on a platform (e.g., a user platform), such as a computer, mobile terminal, and/or the like, that may be used to interact with the service 300. In this regard, the client web browser application 310 may be a generic network communication application for interacting with various network entities, including the service 300. Via the client web browser application 310, a platform, and the user of the platform, may interact with the service 300 to send and receive calculated carbon emissions (and/or any modifications thereof) or information relating to carbon emission values between the client web browser application 310 and the service 300. The client web browser application 310 may facilitate the gathering and storage of selections of privacy options and other data (e.g., user preferences, emission related information, etc.) for subsequent transmission to the service 300.

In an example embodiment, the service 300 may provide users accessing the service 300 via the client application 330 or the client web browser application 310 with access to a CO₂ emission calculation tool along with a carbon emission service, location information service (e.g., based at least in part on CellId), an emission compensation service, a travel type data collection service, and/or the like, as described with respect to FIG. 2. In the alternative or additionally, the service 300 service may be a backend server for CO₂ emission calculation associated and/or employing one or more other functions or internet or network services (e.g., a social networking website, a website, a blog website, a web feed, a widget, and/or the like). In this regard, the service 300 may provide users accessing the service 300 via the client application 330 or the client web browser application 310 with access to statistics of calculated carbon emission data associated with other users. As such, one or more functionalities associated with comparison of carbon emissions between users (e.g., subscribers to the service(s) of the service platform 20), challenge(s) amongst other users to decrease their carbon emissions, competition amongst other users based at least in part on their carbon emissions, and/or the like, may be provided. In some embodiments, a storage device associated with the service 300, such as, for example, the storage device 340, may store emission data of at least one user. In this regard, a user may change device and still be able to keep track of emission rates over a certain period of time.

In an example embodiment, a carbon calculator client application, such as, for example, the carbon calculator 225 of FIG. 2, may send statistical information relating to calculated carbon emission data from the service 300 to a server associated with a social networking website that may be running a social networking application. In the alternative, the carbon calculator client may send the information to a service, such as, for example, the CO₂ emission service 245, which may then send the information to a server associated with a social networking website. The server may have an application that may authenticate the carbon calculator client, such as, for example, the account management provider 320, and the server may parse the uploaded data upon authentication. The server may also have a social networking application program interface that may be used by third party applications to connect to and use the emission data. In this regard, users or subscribers to a social network may calculate their CO₂ emission and cause their CO₂ emissions to be displayed with their user profile. In some embodiments, the CO₂ emission of users may be displayed anonymously. For example, a user may desire to keep track of personal emission rates as well as allowing the emission rates and statistics to be used for various purposes (e.g., zone planning) without revealing their identity. Moreover, users may compare their CO₂ emissions with the CO₂ emissions of other users (e.g., friends, relatives, colleagues, etc.), challenge other users to decrease their carbon emissions, or compete with other users, and/or the like.

Moreover, a user may modify or otherwise define one or more travel methods for one or more trips. The information associated with the trip(s) modified by the user (e.g., statistical information relating to calculated carbon emissions for the trip(s)) may be marked with a flag (e.g., user modified flag). In this regard, the social networking application may monitor the user modified flags to prevent the use of the information associated with the modified trip(s) based at least in part on certain criteria. As such, there may be a predetermined threshold relating to the credibility of the information associated with the modified trip(s). Therefore, if the percentage of trip(s) associated with user modified tag exceeds a certain threshold, the user's overall information associated with trip(s) may be classified as unreliable. Additionally, users may access historical data (i.e., relating to CO₂ emissions) associated with other users. The historical data may be used to provide suggestions regarding how to decrease CO₂ emissions. The historical data may also be used to provide proposals, such as, for example, car pooling, public transportation or other types of ride sharing. The amount of CO₂ that may be saved by the user derived from the use of the suggestion and/or proposed travel method(s) based on the historical data may be provided to the user.

In some embodiments, a carbon calculator client may detect another carbon calculator client in its proximity via, for example, Bluetooth or WLAN. The detection or proximity sensing may be automated or based at least in part on user request. In this, if the users are in the same emission category or classification, the carbon calculator clients may share or exchange information with one another for the purpose of, for example, improving or otherwise minimizing carbon emission levels. In some embodiments, the emission category or classification may be based at least in part on lifestyles (e.g., working professional, students, etc.), travel methods (e.g., car, train, bus, airplanes, etc.), or CO₂ emissions level, and/or the like. In other embodiments, proximity sensing may be used to improve the calculation of emission. In this regard, actual average emission for a vehicle (e.g., car, bus, etc.) may be calculated dynamically or in real time via short range communication aboard the vehicle. As such, updates of vehicle data (e.g., updates of emission values) may be performed dynamically or in real time. In this regard, it may be beneficial to determine the number of users traveling aboard the vehicle. As such, if all the users in the vehicle have a carbon calculator client on their mobile terminals, information relating to calculated carbon emission for each user may be exchanged among the users aboard the vehicle and the carbon emission for each user may be adjusted based at least in part on the information exchanged. In an example embodiment, the total amount of carbon emission for all the users may be divided amongst the users traveling on the vehicle and each user may be attributed an equal amount of emission.

As mentioned above, users, groups of users, and/or communities of various sizes may compare their CO₂ emissions with the CO₂ emissions of other users (e.g., friends, relatives, colleagues, etc.), group of users, and/or communities, challenge other users to decrease their carbon emissions, or compete with other users, and/or the like. In this regard, in some embodiments, there may be a functionality or service that may provide the name or other related information of a most green person and/or group or, in other words, the user with the least CO₂ emissions (e.g. within a certain community or company). In some cases, for example, there may be categories or classifications based at least in part on lifestyles (e.g., working professional, students, etc.), travel methods (e.g., car, train, bus, airplanes, etc.), or CO₂ emissions level, and/or the like. In other embodiments, in the context of games (e.g., online games) and/or other related activities, certain aspects of the game (e.g., bonuses, rewards, enhanced features, and/or the like) may be predicated or otherwise based at least in part on the CO₂ emissions of the user calculated by a carbon calculator client. In yet other embodiments, the emission levels calculated by the carbon calculator client may be used to create a signature image.

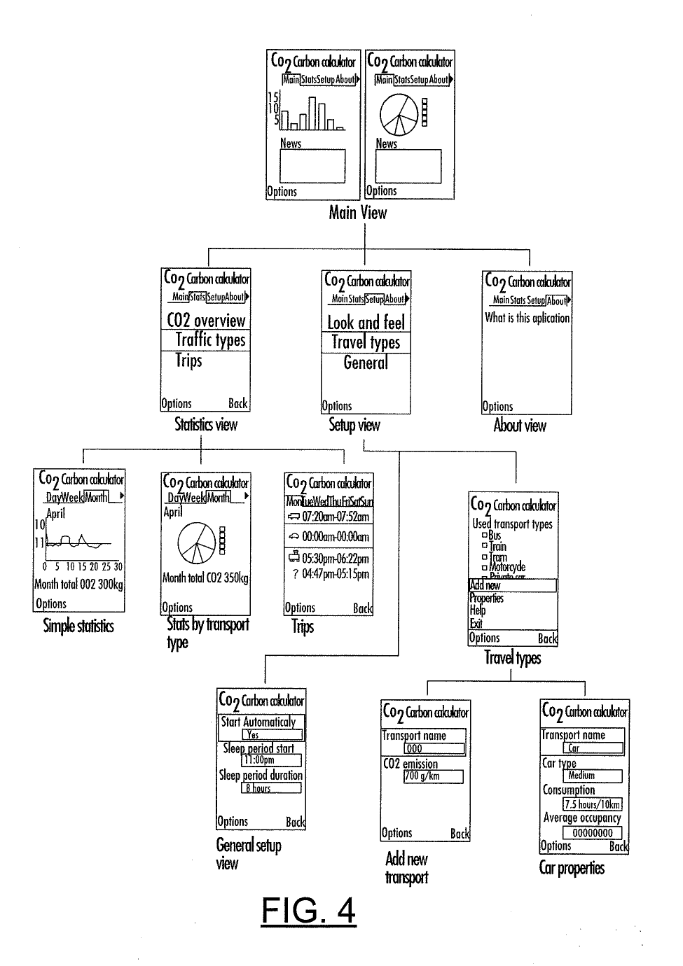

FIG. 4 illustrates a diagram of an exemplary user interface according to the present invention. In this regard, the application may start from a main view. The user may then browse four different tabs which may open up additional views such as, for example, a statistics view, a setup view, an about view. The main view may be available in one tab. The statistics view may include three sub views which may be accessed from a menu. The setup view may also have a similar menu with two different views. In this regard, the travel types view may present a list of available transport methods for recognition that the user can set active on inactive. The travel types view may have two sub views that can be accessed from the left softkey. The sub views may allow the user to add new transport methods or change the properties of the existing ones. The user interface may also include a CO₂ offsetting view (not shown).

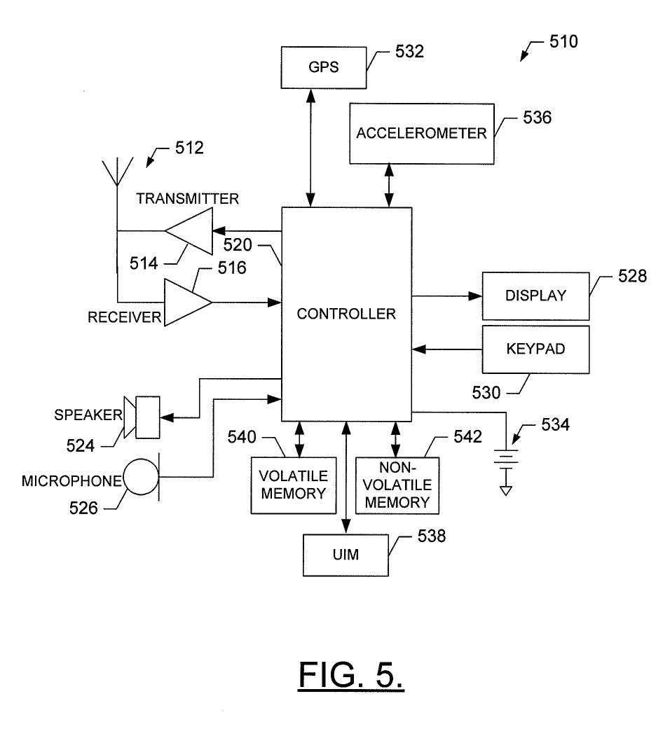

FIG. 5 illustrates a block diagram of a mobile terminal 510 that may benefit from example embodiments of the present invention. It should be understood, however, that a mobile terminal as illustrated and hereinafter described is merely illustrative of one type of mobile terminal that may benefit from some embodiments of the present invention and, therefore, should not be taken to limit the scope of embodiments of the present invention. Several types of mobile terminals, such as mobile phones, mobile communication devices, portable digital assistants (PDAs), pagers, mobile televisions, gaming devices, all types of computers (e.g., laptops or mobile computers), cameras, camcorders, audio/video players, radio, global positioning system (GPS) devices, or any combination of the aforementioned, and other types of communications systems, can readily employ embodiments of the present invention. The mobile terminal 510 may be an example of the apparatus 200 of FIG. 2. However, as indicated above, the apparatus 200 of FIG. 2 could alternatively be embodied as the service 300 of FIG. 1 or even some other device.

The mobile terminal 510 may include an antenna 512 (or multiple antennas) in operable communication with a transmitter 514 and a receiver 516. The mobile terminal 510 may further include an apparatus, such as a controller 520 or other processing element that provide signals to and receives signals from the transmitter 514 and receiver 516, respectively. The signals may include signaling information in accordance with any of numerous wireless communication standards. In this regard, the mobile terminal 510 may be capable of operating with one or more air interface standards, communication protocols, modulation types, and access types.

It is understood that the apparatus, such as the controller 520, may include circuitry for implementing, among others, audio/video and logic functions of the mobile terminal 510. For example, the controller 520 may comprise a digital signal processor device, a microprocessor device, and various analog to digital converters, digital to analog converters, and/or other support circuits. Control and signal processing functions of the mobile terminal 510 may be allocated between these devices according to their respective capabilities. The controller 520 thus may also include the functionality to encode and interleave message and data prior to modulation and transmission. The controller 520 may additionally include an internal voice coder, and may include an internal data modem. Further, the controller 520 may include functionality to operate one or more software programs, which may be stored in memory. For example, the controller 520 may be capable of operating a connectivity program, such as a conventional web browser. The connectivity program may then allow the mobile terminal 510 to transmit and receive web content, such as location-based content and/or other web page content, according to a Wireless Application Protocol (WAP), Hypertext Transfer Protocol (HTTP) and/or the like, for example.

The mobile terminal 510 may also comprise a user interface including an output device such as an earphone or speaker 524, a microphone 526, a display 528, and a user input interface, which may be operationally coupled to the controller 520. As mentioned above, the microphone may record audio data such as, for example, audio data related to a travel method. The user input interface, which allows the mobile terminal 510 to receive data, may include any of a number of devices allowing the mobile terminal 510 to receive data, such as a keypad 530, a touch display (not shown) or other input device. In embodiments including the keypad 530, the keypad 530 may include numeric (0-9) and related keys (#, *), and other hard and soft keys used for operating the mobile terminal 510. Alternatively, the keypad 530 may include a QWERTY keypad arrangement. The keypad 530 may also include various soft keys with associated functions. In addition, or alternatively, the mobile terminal 510 may include an interface device such as a joystick or other user input interface. The mobile terminal 510 further includes a battery 534, such as a vibrating battery pack, for powering various circuits that are used to operate the mobile terminal 510, as well as optionally providing mechanical vibration as a detectable output.

The mobile terminal 510 may further include a user identity module (UIM) 538. The UIM 538 is typically a memory device having a processor built in. The UIM 538 may include, for example, a subscriber identity module (SIM), a universal integrated circuit card (UICC), a universal subscriber identity module (USIM), a removable user identity module (R-UIM), etc. The UIM 538 typically stores information elements related to a mobile subscriber. In addition to the UIM 538, the mobile terminal 510 may be equipped with memory. The mobile terminal 510 may include volatile memory 540 and/or non-volatile memory 542. For example, volatile memory 540 may include Random Access Memory (RAM) including dynamic and/or static RAM, on-chip or off-chip cache memory, and/or the like. Non-volatile memory 542, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 540 non-volatile memory 542 may include a cache area for temporary storage of data. The memories can store any of a number of pieces of information, and data, used by the mobile terminal 510 to implement the functions of the mobile terminal 510.

The mobile terminal 510 may additionally include a GPS 532, an accelerometer 536, other sensory device(s) (e.g., gyro, temperature, pressure, etc.) and/or the like. The mobile terminal may further include a flight mode indicator (not shown) that may, for example, provide information as to whether or not the mobile terminal is in a flight mode status. Moreover, although not shown in FIG. 5, the mobile terminal 10 may communicate in accordance with, for example, radio frequency (RF), Bluetooth (BT), Infrared (IR) or any of a number of different wireline or wireless communication techniques, including LAN, WLAN, Worldwide Interoperability for Microwave Access (WiMAX), WiFi, ultra-wide band (UWB) techniques and/or the like.

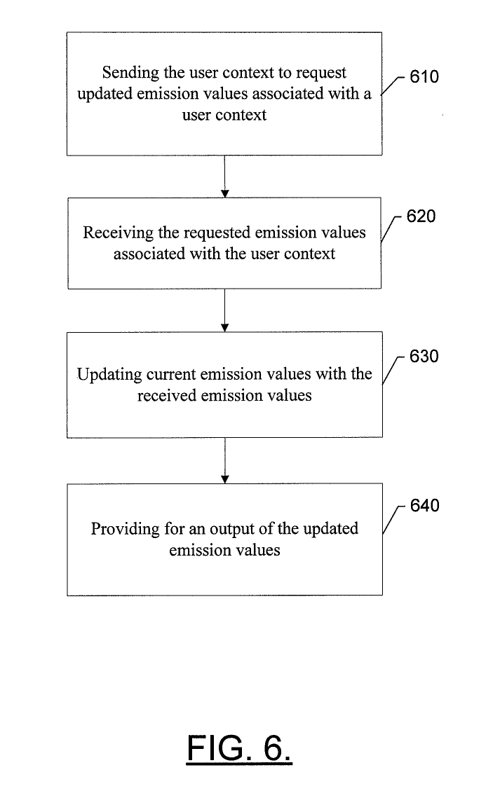

FIG. 6 is a flowchart of a system, method and program product according to example embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device and executed by a processor (e.g., the processor 205). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). Further, the functions specified in the flowchart block(s) or step(s) may be executed in any order. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowcharts, can be implemented by special purpose hardware-based computer systems which perform the specified functions or steps, or combinations of special purpose hardware and computer instructions.

In this regard, one embodiment of a method for providing intelligent updates of emission values as provided in FIG. 6 may include sending a user context to request updated emission values associated with the user context at operation 610. The method may further include receiving the requested emission values associated with the user context at operation 620. At operation 630, the method may further include updating current emission values with the received emission values. Further, at operation 640, the method may include providing for an output of the updated emission values. In some embodiments, the received emissions values may comprise emission values for one or more travel methods (e.g., car, bus, tram, etc). In some embodiments, providing for an output may comprise providing for a display of the emission values. In other embodiments, providing for an output may comprise providing for any storage or transmission of the emission values regardless of whether the output is user perceptible or not. In yet other embodiments, providing output may comprise usage of the emission values, for example, by the carbon calculator 225, to calculate CO₂ emissions.

In an example embodiment, receiving the requested emission values comprises receiving requested carbon dioxide of emission values. In some embodiments, the method may further comprise determining a geographical location based at least in part on a cell identifier. In other embodiments, the method may further comprise receiving emission values based at least in part on the geographical location. In some cases, receiving emission values based at least in part on the geographical location may include receiving emission values for at least one travel method associated with the geographical location.

In an example embodiment, the method may further include receiving an update of at least one travel method associated with the user context. In some cases, receiving an update of at least one travel method may include at least one of receiving an update of emission values associated with the least one travel method or receiving at least one new travel method associated with the user context.

In an example embodiment, the method may further include determining at least one travel method associated with the user context based at least in part on the received emission values. In another example embodiment, the method may further comprise computing emission of at least one travel method based at least in part on the received emission values. In some cases, computing emissions may comprise adjusting computed emissions based at least in part on proximity sensing.

In an example embodiment, an apparatus for performing the method above may include a processor (e.g., the processor 205) configured to perform each of the operations (610-640) described above. The processor may, for example, be configured to perform the operations by executing stored instructions or an algorithm for performing each of the operations. Alternatively, the apparatus may include means for performing each of the operations described above. In this regard, according to an example embodiment, examples of means for performing operations 610 to 640 may include, for example, a processor (e.g., the processor 205), the carbon calculator 225, any other device or circuitry embodied in hardware, software or a combination of hardware and software, and/or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
sending a user context to request updated emission values associated with the user context;
receiving the requested emission values associated with the user context;
updating current emission values with the received emission values; and
providing for an output of the updated emission values.

2. The method of claim 1, wherein receiving the requested emission values comprises receiving requested carbon dioxide emission values.

3. The method of claim 1, further comprising receiving emission values based at least in part on the geographical location.

4. The method of claim 1, further comprising determining a geographical location based at least in part on a cell identifier.

5. The method of claim 3, wherein receiving emission values based at least in part on the geographical location comprises receiving emission values for at least one travel method associated with the geographical location.

6. The method of claim 1, further comprising receiving an update of at least one travel method associated with the user context.

7. The method of claim 6, wherein receiving an update of at least one travel method comprises at least one of receiving an update of emission values associated with the at least one travel method or receiving at least one new travel method associated with the user context.

8. The method of claim 1, further comprising computing emission of at least one travel method based at least in part on the received emission values.

9. The method of claim 8, wherein computing carbon dioxide emissions comprises adjusting computed emissions based at least in part on proximity sensing.

10. The method of claim 1, further comprising determining at least one travel method associated with the user context based at least in part on the received emission values.

11. A computer program product comprising at least one computer-readable storage medium having computer-executable program code portions stored therein, the computer-executable program code instructions comprising:
first program code instructions for sending a user context to request updated emission values associated with the user context;
second program code instructions for receiving the requested emission values associated with the user context;
third program code instructions for updating current emission values with the received emission values; and
fourth program code instructions for providing for an output of the updated emission values.

12. The computer program product of claim 11, wherein the second program code for receiving the requested emission values comprises receiving requested carbon dioxide emission values.

13. The computer program product of claim 11, further comprising instructions for receiving emission values based at least in part on the geographical location.

14. The computer program product of claim 11, further comprising instructions for determining a geographical location based at least in part on a cell identifier.

15. The computer program product of claim 13, wherein the instructions for receiving emission values based at least in part on the geographical location include instructions for receiving emission values for at least one travel method associated with the geographical location.

16. The computer program product of claim 11, further comprising instructions for receiving an update of at least one travel method associated with the user context.

17. The computer program product of claim 16, wherein instructions for receiving an update of at least one travel method include instructions for at least one of receiving an update of emission values associated with the least one travel method or receiving at least one new travel method associated with the user context.

18. The computer program product of claim 11, further comprising instructions for computing emission of at least one travel method based at least in part on the received emission values.

19. The computer program product of claim 18, wherein instructions for computing emissions include instructions for adjusting computed emissions based at least in part on proximity sensing.

20. The computer program product of claim 11, further comprising instructions for determining at least one travel method associated with the user context based at least in part on the received emission values.

21. An apparatus comprising a processor configured to:
send a user context to request updated emission values associated with the user context;
receive the requested emission values associated with the user context;
update current emission values with the received emission values; and
provide for an output of the updated emission values.

22. The apparatus of claim 21, wherein the processor configured to receive the requested emission values comprises the processor configured to receive requested carbon dioxide emission values.

23. The apparatus of claim 21, wherein the processor is further configured to receive emission values based at least in part on the geographical location.

24. The apparatus of claim 21, wherein the processor is further configured to determine a geographical location based at least in part on a cell identifier.

25. The apparatus of claim 23, wherein the processor configured to receive emission values based at least in part on the geographical location comprises the processor further configured to receive emission values for at least one travel method associated with the geographical location.

26. The apparatus of claim 21, wherein the processor is further configured to receive an update of at least one travel method associated with the user context.

27. The apparatus of claim 26, wherein the processor configured to receive an update of at least one travel method comprises the processor further configured to at least one of receive an update of emission values associated with the least one travel method or receive at least one new travel method associated with the user context.

28. The apparatus of claim 21, wherein the processor is further configured to compute emission of at least one travel method based at least in part on the received emission values.

29. The apparatus of claim 28, wherein the processor configured to compute emissions comprises the processor further configured to adjust computed emissions based at least in part on proximity sensing.

30. The apparatus of claim 21, wherein the processor is further configured to determine at least one travel method associated with the user context based at least in part on the received emission values.

31. An apparatus comprising:
means for sending a user context to request updated emission values associated with the user context;
means for receiving the requested emission values associated with the user context;
means for updating current emission values with the received emission values; and
means for providing for an output of the updated emission values.
